(19) United States
(12) Patent Application Publication
(10) Pub. No.: US 2005/0256899 A1
(43) Pub. Date: Nov. 17, 2005

(54) System and method for representing hierarchical data structures

(75) Inventor: Jalpesh Patadia, Boulder, CO (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 10/992,152

(22) Filed: Nov. 18, 2004

Related U.S. Application Data
(60) Provisional application No. 60/571,068, filed on May 14, 2004.

(51) Int. Cl. G06F 7/00

(52) U.S. Cl. 707/102

(57) ABSTRACT

The present invention relates to the creation of trees for representing hierarchical data structures. Trees are created on a server, with the tree having nodes that are associated with paths on a server. Each node is associated with a resource locator indicating data that can be accessed through the tree. A tree manager module generates a state of a tree which is then rendered on a client browser for access by a user. Embodiments of the present invention generate a rendering module which is transmitted to a client for use. The rendering module receives tree information from the server, from which it generates javascript that renders the tree on a client web browser. The present invention is advantageous as it allows customizable client-based rendering of tree structures while utilizing well known mechanisms for creating trees.

### CROSS-REFERENCE TO RELATED APPLICATION

The present application relates to the following application, the contents of which are hereby incorporated by reference in their entirety. SYSTEM AND METHODS FOR AN IMPROVED INTERFACE FOR PORTAL AND WEBSERVER ADMINISTRATION, Application No. 60/571,068, filed on May 14, 2004, Inventor: Christopher E. Bales (Attorney Docket No.: BEAS-01635US0 SRM/BTW).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to systems, methods and computer readable media for serving data content Java servers. The present invention relates more particularly to rendering hierarchical data structures through a Java server.

### BACKGROUND OF THE INVENTION

Since its inception in 1995, the Java programming language has become increasingly popular. Java, which is an interpreted language, enabled the creation of applications which could be run on a wide variety of platforms. This ability to function across a variety of different client platforms and Java's relatively easy implementation of network applications has resulted in its use in endeavors as basic as personal web pages to endeavors as complex as large business-to-business enterprise systems.

Most Java interactions are based around a server product which provides application support and controls access to resources. One such server product is WebLogic Server by BEA Systems of San Jose, Calif.

It is often useful for servers to represent hierarchical data structures such as portals, file systems, and databases through a web interface generated by the server. However, doing so in a manner that is efficient and intuitive has proven difficult. Most solutions have been very narrow in their applications and have faced performance limitations. What is needed is a flexible, intuitive, and powerful mechanism for representing hierarchical data structures generated by a server on a client.

### BRIEF DESCRIPTION OF THE DRAWINGS

FIG. 1 is a block diagram illustrating an overview of a system for accessing a hierarchical data structure in accordance with one embodiment of the present invention.

FIG. 2 is a block diagram illustrating a more detailed interaction between a client system, a server system, and their respective elements.

FIG. 3 is a flow chart illustrating one embodiment of a method for processing a hierarchical data structure.

FIG. 4 is a flow chart illustrating one embodiment of a process for rendering a hierarchical data structure.

FIG. 5 is one embodiment of an interface for interacting with a hierarchical data structure.

### DETAILED DESCRIPTION

The present invention relates to the creation of trees for representing hierarchical data structures. Trees are created on a server, with the tree having nodes that are associated with paths on a server. Each node is associated with a resource locator indicating data that can be accessed through the tree. A tree manager module generates a state of a tree which is then rendered on a client browser for access by a user.

Embodiments of the present invention generate a rendering module which is transmitted to a client for use. The rendering module receives tree information from the server, from which it generates javascript that renders the tree on a client web browser. The present invention is advantageous as it allows customizable client-based rendering of tree structures while utilizing well known mechanisms for creating trees.

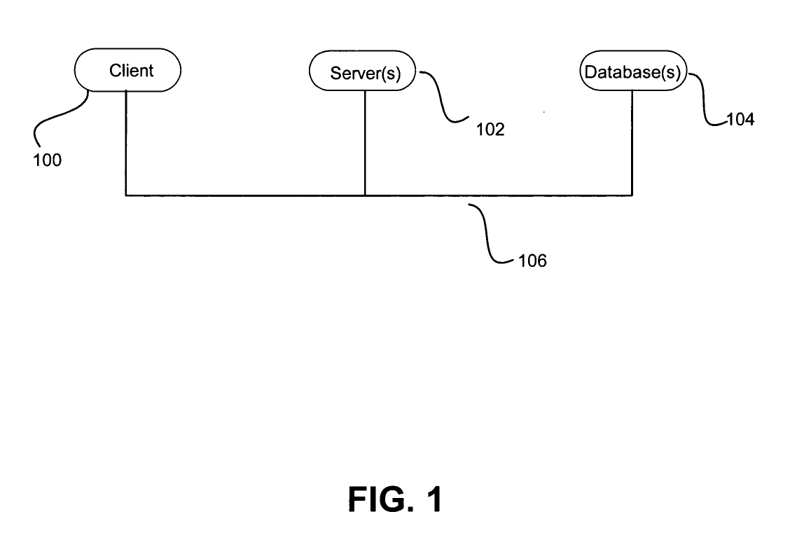

FIG. 1 is a block diagram illustrating an overview of a system for accessing a hierarchical data structure in accordance with one embodiment of the present invention.

Although this diagram depicts objects/processes as logically separate, such depiction is merely for illustrative purposes. It will be apparent to those skilled in the art that the objects/processes portrayed in this figure can be arbitrarily combined or divided into separate software, firmware and/or hardware components. Furthermore, it will also be apparent to those skilled in the art that such objects/processes, regardless of how they are combined or divided, can execute on the same computing device or can be distributed among different computing devices connected by one or more networks or other suitable communication means.

In one embodiment and by way of a non-limiting example, the system can include a client 100, one or more web/application servers 102, and one or more databases 104, connected by one or more networks 106 or other suitable communication means. A network can include but is not limited to: public and/or private networks, wireless networks, optical networks, and satellite based communication links. Other suitable communication means can include but are not limited to: random access memory, file system(s), distributed objects, persistent storage, and inter-processor communication networks. The WebLogic® Server, available from BEA Systems, Inc., is a suitable web/application server in one embodiment. The one or more databases can include but is not limited to: relational databases, object-oriented databases, file systems, or any other kind of persistent storage.

The client 100 preferably includes a web browser capable of processing Java Script and reading HyperText Markup Language(HTML). The server 102 is a conventional Java Server. The databases 104 preferably include one or more hierarchical data structures that are suitable for rendering as tree structures. The server 102 serves pages to the client 100 that render hierarchical data structures.

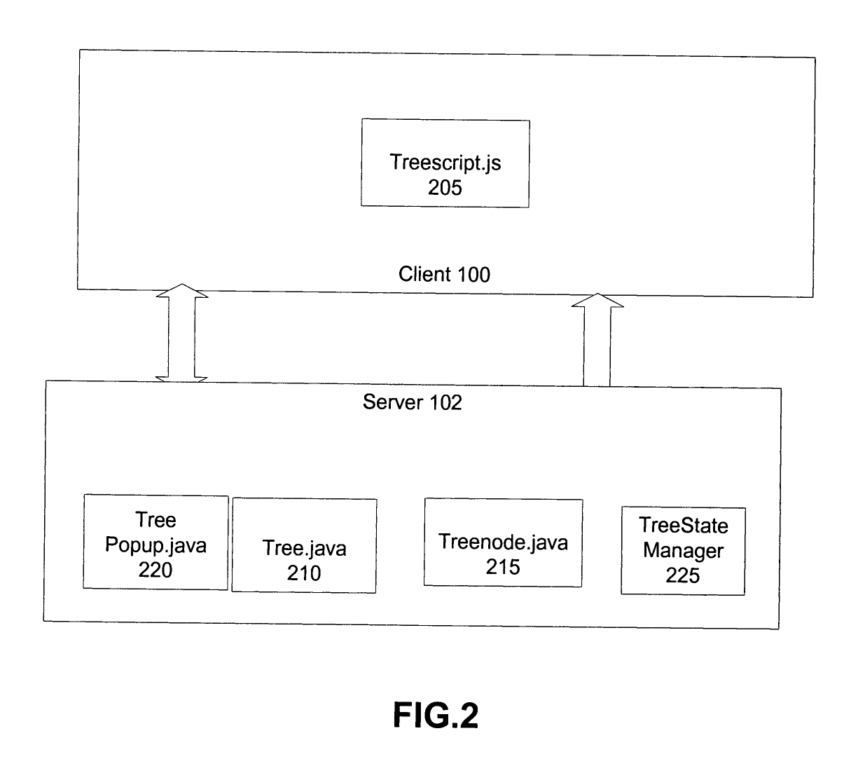

FIG. 2 is a block diagram illustrating a more detailed interaction between the client 100, the server 102, and processes executed thereon. The client 100 runs a treescript.js class 205 which is used to render a tree from information provided by the server 102.

The server 102 maintains a group of classes that are used to generate and operate tree structures and enable their display on the client 100. These classes include Tree.Java classes 210, Tree Popup.Java classes 220, Treenode.java classes 215 and TreeStateManager 225 classes.

The Tree.Java class enables a developer to create a create a tree on the server 102 which can be viewed through the client 100. A tree can be created through the execution of the following code:
public Tree(java.lang.String name)

The parameters include a “name” parameter, which is the name of the tree.

In the present embodiment, tree object creation and tree state management are performed by the server 102, and the tree is rendered by JavaScript on the client. The tree.java module creates a treescript.js module according to the capabilities of the client system and transfers it to the client. In some embodiments, the configuration of the treescript.js file is set according to the type of client used. The treescript.js module can be created dynamically or stored in advance and transferred to the client upon initiation of a session.

The server generates tree state information into Java code which is then consumed by the treescript.js module which creates a visual representation of the tree on the client. The treescript.js file can contain a conversion program that receives tree information as java objects from the tree.java classes on the server and converts the tree state information into javascript code for rendering the tree on the client browser.

The tree.java class, in managing the tree state on the server, additionally includes the following associated methods. These methods are used to set properties for the tree, including node characteristics. For each method, the parentheses indicate a location where parameters are submitted. For those methods in which parameters are listed with a variable name, the “parameters section” describes the data to be submitted with the parameter.

getHighlightNodePath

public java.lang. String getHighlightNodePath( )

This method returns a highlighted node path for a tree. If this parameter is not set, upon rendering the tree will try to find a highlighted node in the TreeStateManager if it exists, and then use it instead.

Returns:
Returns a highlightNodePath.
   setHighlightNodePath
   public void setHighlightNodePath(java.lang.String highlightNodePath)

This method sets a highlighted node path for a tree. If this parameter is not set, upon rendering the tree will try to find a highlighted node in the TreeStateManager if it exists, and then use it instead.

Parameters:
highlightNodePath—The highlightNodePath to set.
   getBaseDirectory
   public java.lang.String getBaseDirectoryo

Returns:
Returns a baseDirectory on the server 102 on which a tree image is located. In some embodiments, this defaults to a default directory, e.g, “tree_images/”.
   setBaseDirectory
   public void setBaseDirectory(java.lang.String baseDirectory)

Parameters:
baseDirectory—Set a base directory where the tree generator will look for images of the tree. Defaults to default directory, e.g. “tree_images/” if not set.
   is Local
   public boolean is Localo

Returns:
Returns whether or not the tree is in a local mode or not. A tree in a local mode will not hit the server in case of an expand or a collapse action.
   setLocal
   public void setLocal(boolean is Local)

Parameters:
is Local—Sets a local mode of the tree. Local mode determines whether the entire tree is generated on the client or, the tree is generated on a need basis only. This value is Boolean, with a positive value indicating that the server is not contacted unless necessary.
   getName
   public java.lang.String getName( )

Returns:
Returns the name of the tree. In some embodiments, each tree has a unique name to avoid conflicts.
   setName
   public void setName(java.lang.String name)

Parameters:
name—Set the name of the tree.
   getRootNode
   public TreeNode getRootNode( )

Returns:
Returns a rootNode of the tree. All trees have a root node.
   setRootNode
   public void setRootNode(TreeNode rootNode)

Parameters:
rootNode—This is method sets a root node.

The server 102 also maintains a treenode.java class. The treenode.java class enables the manipulation of individual nodes on the tree. In some embodiments, there is a separate treenode object for each node on a tree. Each node, when created is associated with a URL that is associated with the node and is loaded when the node is accessed. The class can be used to create a tree node through the following command: public TreeNode(java.lang.String name)
Create a tree node with a given name

The “name” variable indicates a name for the new tree node. The treenode class additionally includes the following associated methods. These methods are used to set properties for the tree nodes. For each method, the parentheses indicate a location where parameters are submitted. For those methods in which parameters are listed with a variable name, the “parameters section” describes the data to be submitted with the parameter.

addChild

public TreeNode

addChild(java.lang. String namejava.lang. String actionjava.lang. String icon)

Add a child node to the current node.

Parameters:
name—The name of the node.
action—The action associated with the node. This can be a URL or a form name
which should be submitted.
icon—The icon which will be used to display the tree node. The same icon will be
used to display expanded/collapsed tree.

Returns:
The newly added node.
   hasChildren
   public boolean hasChildren( )

Return whether or not a node has children or not

setHasChildren

public void setHasChildren(boolean hasChildren)

Set whether or not a node has children or not.

Parameters:
hasChildren—Can be true or false.
   getParent
   public TreeNode getParento

Reference to the parent object of the tree node

Returns:The identity of the parent of the node.

is Expanded

public boolean is Expandedo

Returns:
Returns whether or not the node is expanded or not.
   setExpanded
   public void setExpanded(boolean is Expanded)

If true, sets the state of the node to be expanded when displayed in the tree

Parameters:
is Expanded—The expanded state to be set.
   getNodePath
   public java.lang.String getNodePatho

Return the path associated with the node. This is essentially the path separated by the node delimeter.

Returns:
Returns the nodepath.
   setDisplayName
   public void setDisplayName(java.lang.String displayName)

Sets the displayed name of the TreeNode.

Parameters:
displayName—The displayed name of the tree node.
   setSubmitFormName
   public void setSubmitFormName(java.lang.String submitFormName)

Sets the form to be submitted when this node is clicked. Each node can either have a URL or a form name associated with it.

getSubmitFormName

public java.lang.String getSubmitFormName( )

Returns:
Returns the submitFormName.
   getUrl
   public java.lang.String geturlo

Returns:
Returns a URL associated with the node.
   getUrlTargetName
   public java.lang. String getUrITargetName( )

Returns:
Returns a target of the URL associated with the node.
   setUrl
   public void setUrl(java.lang.String url,
   java.lang.String urlTargetName)

Sets the url associated with the node.

Parameters:
URL—The URL to set.
urlTargetName—If a user wants a URL to open in a separate frame or a window, the name can be specified here. If not specified, when a user clicks on the node, the response to the URL will replace the window's contents.
   getName
   public java.lang.String getName( )

Returns:
Returns the name of the node
   setName
   public void setName(java.lang.String name)

Parameters:
name—Set the name of the node
   getChildren
   public java.util.List getChildreno

Return a list of all the children TreeNode objects of this tree node.

Returns:
A list containing children of the tree node.
   getPopup
   public TreePopup getPopup( )

Returns:
Returns the popup associated with the node, which is invoked when the user right clicks on the node.
   setPopup
   public void setPopup(TreePopup popup)

Parameters:
popup—Set the popup associated with the node.
   getPopupText
   public java.lang.String getPopupTexto

Returns:
Returns the text which is displayed when the user hovers the mouse over the node image.
   setPopupText
   public void setPopupText(java.lang.String popupText)

Parameters:
popupText—Sets the text which is displayed when the user hovers the mouse over the node image.

The treepopup classes 220 control the behavior of popup menus associated with each node in the tree. These classes include methods for enabling and disabling popup menus for each node.

The TreeStateManager 225 class is used to store and maintain a current state of the tree. For each tree, a TreeStateManager instance is generated. The TreeStateManager includes the following associated methods. These methods are used to obtain information about a state of the tree. For each method, the parentheses indicate a location where parameters are submitted. For those methods in which parameters are listed with a variable name, the “parameters section” describes the data to be submitted with the parameter.

getInstance

public static TreeStateManager getInstance(javax.servlet.http.HttpSession session, java.lang.String name)

Return an instance of the TreeStateManager for the tree with the given name.

Parameters:

session—The session object.
name—The name of the tree.
   Returns:
TreeStateManager instance.
   getHihlightedNodePopup
   public TreePopup getHighlightedNodePopup( )

Returns:
Returns the selected popup item of the tree node.
   getHighlightedNodeNanie
   public java.lang.String getHighlightedNodeName( )

Returns:
Returns the highlightedNodeName for a selected node.
   setHighlightedNodeName
   public void setHighlightedNodeName(java.lang.String highlightedNodeName)

Parameters:
highlightedNodeName—The highlightedNodeName to set for a node.
   setHighlightedNodeData
   public void setHighlightedNodeData(java.lang.String highlightedNodeData)

Parameters:
highlightedNodeData—The highlightedNodeData to set.
   getHighlightedNodePath
   public java.lang. String getHighlightedNodePath( )

Returns:
Returns the highlightedNodePath for a node.
   setHighlightedNodePath
   public void setHighlightedNodePath(java.lang.String highlightedNodePath)

Parameters:
highlightedNodePath—The highlightedNodePath to set.
   processState
   public void processState(javax.servlet.http.HttpServletRequest request)

Process the state of the tree after a user has performed either of the following actions in the tree—expanded a node, collapsed a node, zoomed in or out, paged through a window or selected a node.

Parameters:
request—The request object which would contain this information.
   is NodePathPaginated
   public boolean is NodePathPaginated(java.lang.String nodePath)

Return whether or not the given node path is paginated or not.

Parameters:
nodePath—The path of the node

Returns:
true or false depending whether the node is paginated or not.
   addNodePathAsPaginated
   public void addNodePathAsPaginated(java.lang.String nodePath)

Force a particular node path to be paginated, if it is not already paginated.

Parameters:
nodePath—The path of the node.
   removeNodePathAsPaginated
   public void removeNodePathAsPaginated(java.lang.String nodePath)

Remove the given node as being paginated.

setExpandNodesFromPath

public void setExpandNodesFromPath(java.lang.String nodePath)

Marks all nodes below the given path to be expanded.

Parameters:
nodePath—The path to the tree node.
   getExpandNodesFromPath
   public java.lang.String getExpandNodesFromPath( )
   addNodeAsExpanded
   public void addNodeAsExpanded(java.lang.String nodepath)

Add a particular node, identified by its path as expanded in the tree.

Parameters:
nodePath—
   is NodeExpanded
   public boolean is NodeExpanded(java.lang.String nodepath)

Indicate whether or not the given node, identified by its path is expanded or not

Parameters:
nodePath—The node path

Returns: A Boolean value indicating whether a node is expanded.

In some embodiments, the system closely mimics the APIs between corresponding java objects and javascript objects so as to allow for easy data transfer between the two mediums. For example, the treejava object has a similar API to the JSTree object in treescript.js. and the treenode.java object has a similar API to the JSTreeNode object in treescript.js. This interoperability allows for easy conversion to current embodiments from previous designs.

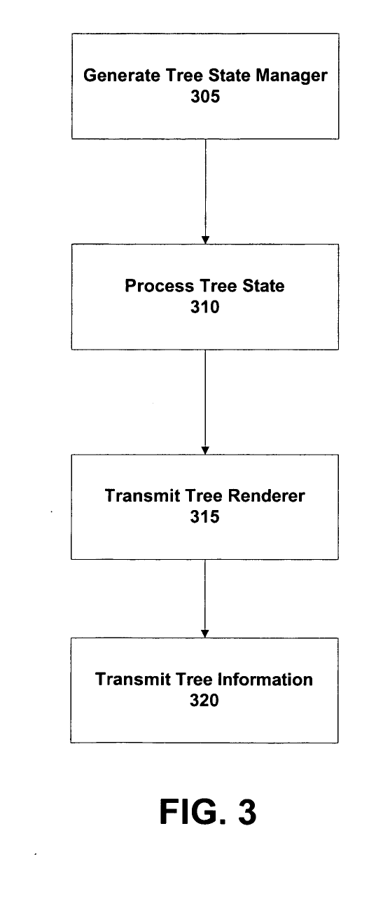

FIG. 3 is a flow chart illustrating one embodiment of a process for loading a tree representing a hierarchical data structure. In step 305, the server generates a tree state manager for a tree. This step is preferably performed when a user of the client 100 access a page listing a tree or selects a tree related link. A tree state manager object for a tree titled “local tree” can be created through the execution of the following code

TreeStatemanager treestatemanager=TreeStatemanager.getinstance(session, “localTree”).

In step 310, the treestatemanager object determines a state of a tree. The state of the tree can include a current node arrangement of the tree as well. In the present embodiment, the tree state can be processed in response to a user selecting a node on a tree, but in alternate embodiments the step can be performed automatically or in response to another action. Step 310 can be implemented when the following code is executed:

Treestatemanager.processState(request). The server can also return information for a particular node on a tree. This information can include the URL associated with the node as well as supplementary information associated with the node.

In step 315, the server transmits a renderer such as the treescript.js module. The treescript.js module receives information from the server, which is used to generate javascript code for rendering the tree on the client.

In step 320, the server transmits tree information to the client. This information can be transmitted in a variety of formats. In some embodiments, the tree information can be transmitted as a text file. In alternate embodiments, formats such as extensible Markup Language documents or other formats can be used. This information is used by the treescript.js module on the client to generate javascript code for presenting the tree to a user.

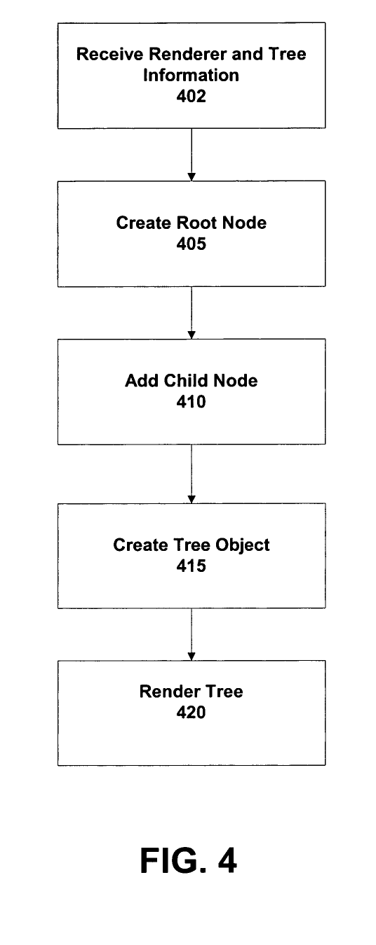

FIG. 4 is a flow chart illustrating one embodiment of a process for rendering a hierarchical data structure. This process can be performed in JavaScript generated by the treescript.js module in the client. In step 402 a rendering module is received from the server. In some embodiments, this rendering module is the treescript.js module. During this step tree state information can also be received by the treescript.js for rendering the tree.

In step 405, a root node is created for the new tree. The root node is the core element of the tree and all child nodes are associated with it. The instructions for creating a root node titled “local tree root” can be represented as: TreeNode root=new TreeNode (“Local Tree Root”). These instructions can be generated by the treescript.js module when it receives tree state information from the server.

In step 410 a child node is added to the root node. The child is associated with a root node and includes a name “firstChild”, an action that is performed when the node is selected(form submission) and an icon(folder.gif) to represent the node in a graphical interface. This action can be implemented by the following code, which is also generated by the treescript.js module when it receives tree state information from the server: addChild(“firstChild”, submitform, folder.gif)

In step 415 a tree object is created that references the root node created in step 405. The tree object can be implemented through the following code: Tree localTree=new Tree (“localTree”, root, true”).

In step 420, the tree is rendered and presented to a user when the javascript is executed by client web browser.

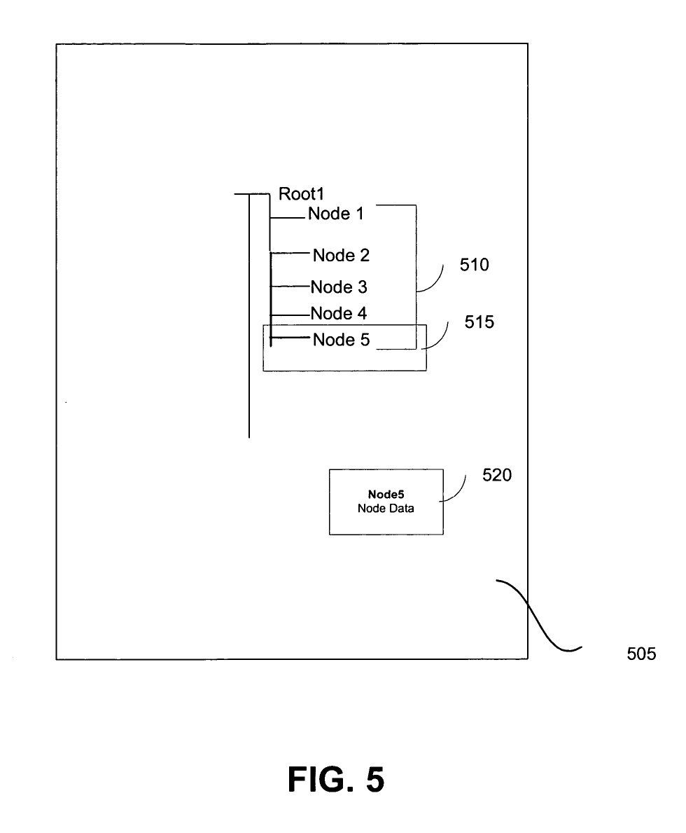

FIG. 5 is one embodiment of an interface for interacting with a hierarchical data structure. A browser window includes a tree structure 510 which represents a hierarchical data structure such as a file system. A root node supports a group of child nodes that are associated with the root node. In some embodiments, some of the child nodes include their own child nodes. In the present embodiment, one of the nodes is highlighted 515. In some embodiments, items on the tree can be selected by moving a mouse arrow or other selector over the node of the tree. A JavaScript interface, maintained by the treescript.js module generates the interface. A node information window 520 displays node data which can include a URL associated with the node, or user-configured data.

The tree nodes can be expanded to display subnodes by selecting the nodes with a pointer or other interface tool. Additionally, the trees, when expanded can display paginated hierarchies. Thus, if a node, once expanded, displays more elements that can be displayed on a single page, the tree can optionally load only those nodes that would be displayed on the first page, rather than all of the nodes, and load the new nodes as necessary.

It should be noted that while the embodiments used herein use Java and Javascript, in alternate embodiments other languages can be used to produce the tree data on the server. Additionally, other scripting languages can be used to render the tree on the client. Java and Javascript are merely used for illustrative purposes in the present application.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention.

1. A method on a client for representing a hierarchy in a server as a tree, the method comprising:
receiving code containing tree information from the server; and
utilizing the code containing tree information to generate code for:
rendering a root node of the tree on the client; and
rendering a first child node of the tree on the client.

2. The method of claim 1, wherein the code for rendering comprises javascript code.

3. The method of claim 1, further comprising utilizing the code containing tree information to generate code for rendering a second child node associated with the root node.

4. The method of claim 1, further comprising utilizing the code containing tree information to generate code for rendering a second child node associated with the first child node.

5. The method of claim 1, wherein the tree represents a directory structure.

6. A method for processing a tree state for a tree representing a hierarchy, the method comprising:
transmitting a rendering module to a client, the rendering module configured to render a tree on the client in response to receiving code containing tree state information;
generating a tree state manager object;
utilizing the tree state manager object to process a state of the tree; and
transmitting code containing the state of the tree to the rendering module.

7. The method of claim 6, wherein the tree represents a directory structure.

8. The method of claim 6, wherein the tree comprises child nodes and the child nodes are identified by a path in a file system.

9. The method of claim 6, wherein the code comprises java code.

10. A machine readable medium having instructions stored thereon that when executed by a processor cause a system to:
receive code containing tree information for representing a hierarchical data structure on a server from the server; and
utilize the code containing tree information to generate code for:
rendering a root node of the tree on the client; and
rendering a first child node of the tree on the client.

11. The machine readable medium of claim 10, wherein the code for rendering comprises javascript code.

12. The machine readable medium of claim 10, further comprising instructions that when executed by the processor cause the system to utilize the code containing tree information to generate code for rendering a second child node associated with the root node.

13. The machine readable medium of claim 10, further comprising instructions that when executed by the processor cause the system to utilize the code containing tree information to generate code for rendering a second child node associated with the first child node.

14. The machine readable medium of claim 10, wherein the tree represents a directory structure.

15. A machine readable medium having instructions stored thereon that when executed by a processor cause a system to:
transmit a rendering module to a client, the rendering module configured to render a tree on the client in response to receiving code containing tree state information;
generate a tree state manager object;
utilize the tree state manager object to process a state of a tree representing a hierarchy; and
transmit code containing the state of the tree to the rendering module.

16. The machine readable medium of claim 15, wherein the tree represents a directory structure.

17. The machine readable medium of claim 15, wherein the tree comprises child nodes and the child nodes are identified by a path in a file system.

18. The machine readable medium of claim 15, wherein the code comprises java code.

19. A system in a client for representing a hierarchy on a server as a tree, the system comprising:
a client module configured to receive a rendering module;
the rendering module configured to:
receive code containing tree information from the server; and
utilize the code containing tree information to generate code for:
rendering a root node of the tree on the client; and
rendering a first child node of the tree on the client.

20. The system of claim 19, wherein the code for rendering comprises javascript code.

21. The system of claim 19, wherein the hierarchy comprises a directory structure.

22. The system of claim 19, wherein the rendering module is further configured to utilize the code containing tree information to generate code for rendering a second child node of the tree on the client.
